(19) United States
(12) Patent Application Publication
(10) Pub. No.: US 2024/0093647 A1
(43) Pub. Date: Mar. 21, 2024

(54) METHOD OF CONTROLLING A DEVICE FOR SUPPLYING A PROPULSION SYSTEM OF AN AIRCRAFT AND SUPPLY DEVICE ENABLING EXECUTION OF THAT METHOD

(71) Applicant: Airbus Operations SAS, Toulouse (FR)

(72) Inventor: Mathieu BELLEVILLE, TOULOUSE (FR)

(21) Appl. No.: 18/469,251

(22) Filed: Sep. 18, 2023

(30) Foreign Application Priority Data
Sep. 20, 2022 (FR) 2209514

(51) Int. Cl. F02C 9/40; F02C 3/22; F02C 9/26

(52) U.S. Cl. CPC F02C 9/40; F02C 3/22; F02C 9/26

(57) ABSTRACT

A method of controlling a fuel supply device of at least one aircraft propulsion system. The method includes a step of determining the state of the fuel flowrate control system following a change of state that has moved it away from an initial state, a step of modifying the pressure of the fuel as a function of the state of the fuel flowrate control system that has been determined, and a step of changing the state of the fuel flowrate control system to return it to or toward the initial state.

### CROSS-REFERENCES TO RELATED APPLICATIONS

This application claims the benefit of the French patent application No. 2209514 filed on Sep. 20, 2022, the entire disclosures of which are incorporated herein by way of reference.

### FIELD OF THE INVENTION

The present invention relates to a method of controlling a device for supplying a propulsion system of an aircraft and a supply device enabling execution of that method.

### BACKGROUND OF THE INVENTION

In accordance with one embodiment an aircraft includes at least one supply device connecting at least one fuel tank and at least one propulsion system, which device is configured to supply the propulsion system with fuel.

In the case of an aircraft operating on hydrogen, the fuel tank is configured to store hydrogen in the cryogenic liquid state at a storage pressure less than or equal to 5 bar and at a storage temperature less than or equal to 25 K (approximately −250° C.). Given that at the moment of its combustion hydrogen must be at a combustion temperature on the order of 300 K (approximately +27° C.) and a combustion pressure generally between less than 1 bar (in cruising flight) and approximately 60 bar (maximum power on the ground) inclusive, the supply device includes a pressurization system configured to compress the hydrogen from the storage pressure to the combustion pressure and a heat exchanger configured to heat the hydrogen from the storage temperature to the combustion temperature. The maximum pressure of the pressurization system may be equal to twice the combustion pressure, i.e., up to approximately 150 bar.

Additionally, the supply device includes a system for controlling the flowrate of the fuel delivered to the propulsion system, in particular enabling regulation of its engine speed. As a function of the desired engine speed, the flowrate of hydrogen feeding the propulsion system must be able to vary over a wide range from 6 g/s to 600 g/s, which corresponds to a variation from 1 to 100 of the flow section of the fuel flowrate control system.

A flowrate control system operating over this wide a range is complex and difficult to design.

The present invention aims to remedy some or all of the disadvantages of the prior art.

### SUMMARY OF THE INVENTION

To this end the invention has for an object a method of controlling a fuel supply device of at least one aircraft propulsion system, the supply device including at least one fuel pressurization system configured to compress the fuel to a given pressure and at least one fuel flowrate control system configured to occupy different states over a range of states bounded by first and second extreme states, to deliver to the propulsion system a given quantity of fuel at a given fuel pressure in each of the states, the fuel flowrate control system being configured to occupy an initial state.

In accordance with the invention, the method includes a step of determination of the state of the fuel flowrate control system following a change of state that has moved it away from the initial state, followed by a step of modification of the pressure of the fuel generated by the fuel pressurization system as a function of the state of the fuel flowrate control system that has been determined, followed by a step of changing the state of the fuel flowrate control system to return it to or toward the initial state.

In the case of an aircraft operating on hydrogen, this method enables the quantity of fuel delivered to the propulsion system to be varied over a wide range, even using a fuel flowrate control system having a restricted operating range.

In accordance with another feature, the step of determination of the state of the fuel flowrate control system comprises determining a direction of variation of the state of the fuel flowrate control system between a first direction of increase from the initial state toward the first extreme state and a second direction of reduction from the initial state toward the second extreme state. Additionally, the step of modification of the pressure generated by the fuel pressurization system comprises modifying the pressure generated in the same direction of variation as the direction of variation of the state of the fuel flowrate control system that has been determined, the step of changing the state of the fuel flowrate control system consisting in modifying it in a direction of variation opposite the direction of variation that has been determined.

In accordance with another feature, the step of determination of the state of the fuel flowrate control system consists in determining a value of the change of state between the initial state and the state that has been determined. Additionally, the step of modification of the pressure generated by the fuel pressurization system comprises modifying the pressure generated by a value that is a conversion function of the value of the change of state that has been determined, the step of changing the state of the fuel flowrate control system comprising modifying it by a value substantially equal to the change of state value that has been determined.

In accordance with another feature, the conversion function has an adjustable gain. Additionally, the control method includes a step of adjustment of the gain of the conversion function in such a manner as to prevent the fuel flowrate control system becoming immobilized in one of the first or second extreme states or oscillating.

In accordance with another feature, the range of states of the fuel flowrate control system includes a median state such that the range of states includes approximately as many states between the median state and the first extreme state as between the median state and the second extreme state, the initial state corresponding to the median state.

In accordance with another feature, the state of the fuel flowrate control system is determined by a sensor configured to generate a state signal as a function of the state that has been determined by the sensor. Additionally, the control method includes a step of processing the state signal.

In accordance with another feature, the method includes a step of determination of at least one intermediate state between the initial state and the state that has been determined by the sensor. Additionally, for each intermediate state, the method includes a step of modification of the pressure generated by the fuel pressurization system as a function of the state that has been determined or of the preceding intermediate state of the fuel flowrate control system followed by a step of changing the state of the fuel flowrate control system to return it to or toward the initial state.

The invention also has for an object a device for supplying with fuel an aircraft propulsion system enabling execution of the control method having any of the above features. In accordance with the invention, the fuel flowrate control system includes a sensor configured to determine the state of the fuel flowrate control system and to generate a state signal as a function of the state of the fuel flowrate control system that has been determined. Additionally, the supply device is configured to control the fuel pressurization system and the fuel flowrate control system as a function of the state signal generated by the sensor.

In accordance with another feature, the sensor is configured to determine the state of the fuel flowrate control system, a direction of variation of the state and the change of state value between the initial state and the state that has been determined.

In accordance with another feature, the range of states of the fuel flowrate control system includes a median state such that the range of states includes approximately as many states between the median state and the first extreme state as between the median state and the second extreme state. Additionally, the initial state corresponds to the median state.

### BRIEF DESCRIPTION OF THE DRAWINGS

Other features and advantages will emerge from the following description of the invention given by way of example only with reference to the appended drawings, in which:

FIG. 1 is a schematic representation of an aircraft,

FIG. 2 is a schematic representation of a propulsion system supply device depicting one embodiment of the invention.

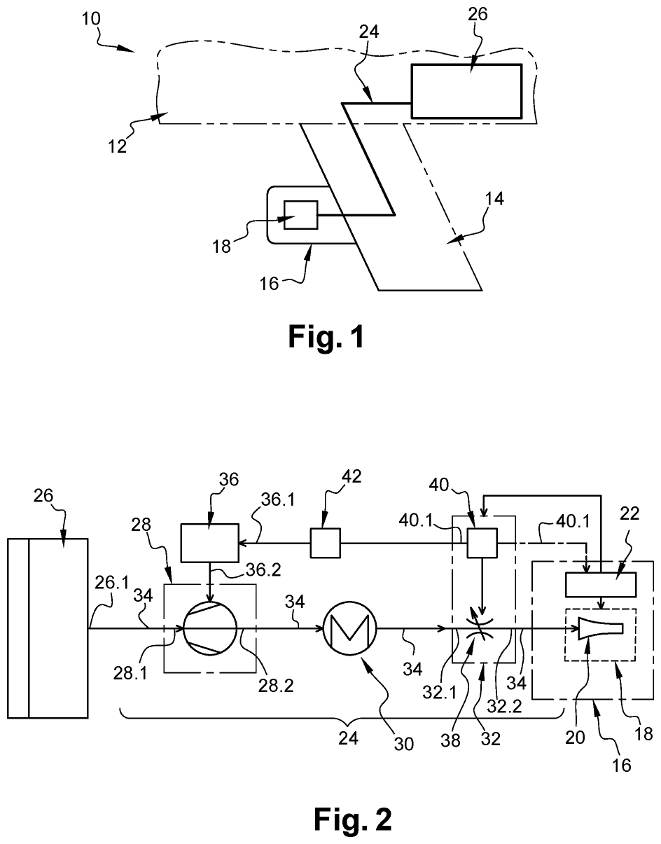

### DETAILED DESCRIPTION OF THE PREFERRED EMBODIMENTS

In accordance with one embodiment, an aircraft 10 comprises a fuselage 12, wings 14 and a plurality of propulsion assemblies 16 connected to the fuselage 12 or to the wings 14.

Each propulsion assembly 16 comprises a propulsion system 18 including at least one combustion chamber supplied by at least one injector 20 configured to inject a given quantity of fuel into the combustion chamber and an engine control system 22 configured to control the propulsion system 18 and, in particular, to regulate its engine speed.

In the case of an aircraft operating on hydrogen, the latter has, on its introduction into the combustion chamber, a given combustion pressure and temperature. To give an order of magnitude the combustion pressure is between 1 and 60 bar inclusive and the combustion temperature is of the order of 300 K (approximately +27° C.).

The aircraft 10 includes at least one fuel supply device 24 connecting at least one fuel tank 26 and at least one propulsion system 18, which device is configured to supply the propulsion system 18 with fuel.

In the case of an aircraft operating on hydrogen, the fuel tank 26 is configured to store hydrogen in the cryogenic liquid state at given storage pressure and temperature. The fuel tank 26 has at least one outlet 26.1. To give an order of magnitude the storage pressure is less than or equal to 5 bar and the storage temperature is less than or equal to 25 K (approximately −250° C.).

In accordance with one embodiment, the fuel supply device 24 includes at least one fuel pressurization system 28, at least one fuel heating system 30, at least one fuel flowrate control system 32 and a set of pipes 34 configured to route the fuel from the fuel tank 26, more particularly, from the outlet 26.1 of the fuel tank 26, to the propulsion system 18, and, more particularly, to at least one injector 20 of the propulsion system 18, via the fuel pressurization system 28, the fuel heating system 30 and the fuel flowrate control system 32.

In accordance with one configuration, the fuel heating system 30 includes at least one heat exchanger that has at least one inlet and at least one outlet and is configured to generate an increase in the temperature of the fuel between the inlet and the outlet. In accordance with one operating mode, the heat exchanger is fed with a hot fluid taken from the propulsion assembly 16. The fuel heating system 30 is not described further because it may be identical to that of the prior art.

The fuel pressurization system 28 includes at least one first inlet 28.1 and at least one first outlet 28.2. It is configured to compress the fuel to a given variable pressure. Additionally, the fuel pressurization system 28 includes a control unit 36 configured to receive at least one first input signal 36.1, the fuel pressurization system 28 compressing the fuel to a given outlet pressure at the first outlet 28.2 as a function of the input signal 36.1 received by the control unit 36.

In accordance with one embodiment, the fuel pressurization system 28 includes a pump, in particular, a high-pressure pump. In accordance with this embodiment, the outlet pressure of the pump is a function of the rotation speed of the pump, the outlet pressure increasing as the rotation speed itself increases. Additionally, the control unit 36 is configured to generate a control signal 36.2 as a function of the input signal 36.1, enabling the rotation speed of the pump to be varied.

The fuel flowrate control system 32 has at least one second inlet 32.1, at least one second outlet 32.2 and a variable flow section between the second inlet and outlet 32.1, 32.2. Thus the fuel flowrate control system 32 is configured to occupy different states over a range of states bounded by a first extreme state corresponding to a maximum flow section and a second extreme state corresponding to a minimum flow section. In each state the fuel flowrate control system 32 delivers to the propulsion system 18 a given quantity of fuel at a given fuel pressure.

The range of states of the fuel flowrate control system 32 includes a median state such that the range of states includes approximately as many states between the median state and the first extreme state as between the median state and the second extreme state. In the median state the fuel flowrate control system 32 has a median flow section approximately equal to half the sum of the minimum and maximum flow sections.

In accordance with one embodiment, the fuel flowrate control system 32 includes a valve 38 configured to occupy different positions between a first extreme position corresponding to the first extreme state of the fuel flowrate control system 32 in which the valve 38 has a maximum flow section and a second extreme position corresponding to the second extreme state of the fuel flowrate control system 32 in which the valve 38 has a minimum flow section, the valve 38 being configured to occupy a median position approximately equidistant from the first and second extreme positions.

The fuel flowrate control system 32 includes a sensor 40 configured to determine the state of the fuel flowrate control system 32 and to generate a state signal 40.1 as a function of the state of the fuel flowrate control system 32 that has been determined by the sensor 40. In accordance with one embodiment the sensor 40 is configured to determine the position of the valve 38 and to generate a state signal 40.1 as a function of the position of the valve 38 that has been determined.

At the very least the fuel supply device 24 includes at least one fuel pressurization system 28 configured to compress the fuel to a given pressure and at least one fuel flowrate control system 32 configured to occupy different (known or discrete) states and, for each state, to deliver to the propulsion system 18 a given quantity of fuel. The fuel flowrate control system 32 is configured to occupy an initial state in which the fuel flowrate control system 32 delivers an initial quantity of fuel.

A method of controlling the fuel supply device 24 includes, following a change to the quantity of fuel delivered to the propulsion system 18 during which the state of the fuel flowrate control system 32 is modified away from the initial state, a step of determination of the state of the fuel flowrate control system 32 followed by a step of modification of the pressure generated by the fuel pressurization system 28 as a function of the state of the fuel flowrate control system 32 that has been determined followed by a step of changing the state of the fuel flowrate control system 32 moving it back to or toward the initiate state. The pressure modification and change of state steps are not coordinated so as to maintain substantially constant the quantity of fuel delivered to the propulsion system 18. The fuel flowrate control system 32 reacts to the change of pressure at its inlet in order to maintain delivery of the required quantity of fuel to the propulsion system 18.

The step of changing the state of the fuel flowrate control system is carried out in reaction to the step of modification of the pressure of the fuel generated by the fuel pressurization system.

The fuel flowrate delivered to the propulsion system depends on the pressure of the fuel, on the temperature of the fuel and on the flow section for the fuel leading to the combustion chamber. The fuel flowrate control system controls only the flow section for the fuel leading to the combustion chamber. When the pressurization system increases the pressure of the fuel the fuel flowrate control system observes an increase in the fuel flowrate and reacts by commanding a reduction of the fuel flowrate.

In accordance with the invention there are therefore two independent and non-coordinated feedback loops: a first feedback loop that controls the flowrate of the fuel by action on the flow section for the fuel leading to the combustion chamber, the effective flowrate depending on the upstream fuel pressure, and a second feedback loop that controls the pressure of the fuel, there being a free choice of pressure but that choice is conditioned by the two extreme states of the fuel flowrate control system.

For example, the change in the quantity of fuel delivered to the propulsion system 18 occurs in particular on a change of the engine speed of the propulsion system 18.

In the case of an aircraft operating on hydrogen, this method makes it possible to be able to vary the quantity of fuel delivered to the propulsion system 18 over a wide range even using a fuel flowrate control system 32 having a restricted operating range.

In accordance with one embodiment, the step of determination of the state of the fuel flowrate control system 32 comprises determining a direction of variation of the state of the fuel flowrate control system 32 between a first direction of increase from the initial state toward the first extreme state and a second direction of reduction from the initial state toward the second extreme state. Additionally, the step of modification of the pressure generated by the fuel pressurization system 28 comprises modifying the pressure generated in the same direction of variation as the direction of variation of the state of the fuel flowrate control system 32 that has been determined. The step of changing the state of the fuel flowrate control system 32 comprises modifying it in a direction of variation opposite to the direction of variation that has been determined. Thus, if the state that has been determined is situated between the initial state and the first extreme state, which corresponds to a variation of the state in a first direction increasing the flow section, the pressure generated by the fuel pressurization system 28 is increased. The pressure generated by the fuel pressurization system 28 being increased, the state of the fuel flowrate control system 32 is modified in order to maintain the required fuel flowrate, which finally moves it to or toward the initial state. To the contrary, if the state that has been determined is situated between the initial state and the second extreme state, which corresponds to a variation of the state in a second direction reducing the flow section, the pressure generated by the fuel pressurization system 28 is reduced. The pressure generated by the fuel pressurization system 28 being reduced, the state of the fuel flowrate control system 32 is modified in order to maintain the required fuel flowrate, which finally moves it to or toward the initial state.

In accordance with one configuration, the initial state corresponds to the median state, which makes it possible to obtain an operating range as wide in the first direction of increase as in the second direction of reduction.

In accordance with one configuration, the step of determination of the state of fuel flowrate control system 32 comprises determining a direction of variation of the state of the fuel flowrate control system 32 and a value of the change of state between the initial state and the state that has been determined. Additionally, the step of modification of the pressure generated by the fuel pressurization system 28 comprises modifying the pressure generated in the same direction of variation as the direction of variation of the state of the fuel flowrate control system 32 that has been determined and a value that is a function for conversion of the value of the change of state that has been determined. Thereafter, the step of changing the state of the flowrate control system 32 comprises modifying it in a direction of variation opposite the direction of variation that has been determined and a value substantially equal to the change of state value that has been determined.

In accordance with this configuration, the sensor 40 is configured to determine the state of the fuel flowrate control system 32, a direction of variation of the state and the value of the change of state between the initial state and the state that has been determined.

In accordance with a first embodiment, the sensor 40 is configured:
to determine as a function of the direction of variation and of the value of the change of state that it has determined the direction of variation and the value of the change of pressure that must be applied by the fuel pressurization system 28,
to generate a state signal 40.1 as a function of the direction of variation and of the value of the change of pressure that have been determined, and
to transmit this state signal 40.1 directly to the control unit 36 as an input signal 36.1, the fuel pressurization system 28 compressing the fuel to a new value as a function of the input signal 36.1 received.

In accordance with a second embodiment, the sensor 40 is configured to generate a state signal 40.1 as a function of the direction of variation and of the value of the change of state determined by the sensor 40.

This state signal 40.1 is transmitted directly to the control unit 36 as an input signal 36.1. The control unit is configured to determine as a function of the input signal 36.1 the direction of variation and the value of the change of pressure that the fuel pressurization system 28 must produce and to generate a control signal 36.2 as a function of the direction of variation and of the value of the change of pressure that have been determined.

Alternatively, the state signal 40.1 is transmitted to the engine control system 22. The latter is configured to determine as a function of the state signal 40.1 received the direction of variation and the value of the change of pressure that the fuel pressurization system 28 must produce and to generate an input signal 36.1 to the control unit 36 as a function of the direction of variation and of the value of the change of the pressure that have been determined.

In accordance with one configuration, the engine control system 22 is able to control independently the fuel pressurization system 28 and the fuel flowrate control system 32.

Regardless of the embodiment, the supply device is configured to control the fuel pressurization system 28 and the fuel flowrate control system 32 as a function of the state signal 40.1 generated by the sensor 40, the fuel flowrate control system 32 being controlled in reaction to the control of the fuel pressurization system 28. In particular, the supply device is configured to control the fuel pressurization system 28 as a function of the state signal generated by the sensor 40 and then, in reaction to the change of pressure delivered by the fuel pressurization system 28, to control the fuel flowrate control device 32. The supply device thus controls the fuel pressurization system 28 and the fuel flowrate control system 32 in a decoupled, i.e., non-coordinated, manner.

In accordance with one operating mode, the control method includes a step of processing the state signal 40.1, for example by means of a low-pass filter or by hysteresis, if stabilization or prevention of oscillation is required. For example, it may also be required that the fuel flowrate control system reacts rapidly while the pressurization system reacts more slowly. For example, the fuel supply device 24 includes a low-pass filter 42 for processing the state signal 40.1. In the case of a fuel pressurization system including a pump, this embodiment enables excessively sudden variations in the speed of the pump to be prevented, in particular if the pump has insufficient momentum.

The conversion function enabling the value of the change of pressure to be determined from the value of the change of state has a gain adjustable with reference to the required dynamic of the propulsion system 18. The method of controlling the fuel supply device 24 includes a step of adjustment of the gain of the conversion function in such a manner as to prevent the fuel flowrate control system 32 becoming immobilized in the first or second extreme state or oscillating.

In accordance with a first operating mode, the change in pressure generated by the fuel pressurization system 28 and the return of the fuel flowrate control system 32 to the median state are accomplished in one phase.

In accordance with a second operating mode, the modification of the pressure generated by the fuel pressurization system 28 and the return of the fuel flowrate control system 32 to the initial state are accomplished in at least two phases. This second operating mode enables prevention of phenomena of resonance between the fuel pressurization system 28 and the fuel flowrate control system 32.

In accordance with this second operating mode, the method includes a step of determination of at least one intermediate state between the initial state and the state that has been determined by the sensor 40. For each intermediate state, the method includes a step of modification of the pressure generated by the fuel pressurization system 28 as a function of the state that has been determined or of the preceding intermediate state of the fuel flowrate control system 32 followed by a step of changing the state of the fuel flowrate control system 32 to return it to or toward the initial state.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of controlling a fuel supply device of at least one aircraft propulsion system, the fuel supply device including at least one fuel pressurization system configured to compress fuel to a given pressure and at least one fuel flowrate control system configured to occupy different states over a range of states bounded by first and second extreme states, to deliver to the propulsion system a given quantity of fuel at a given fuel pressure in each of the states, and to occupy an initial state, wherein the method comprises:
determining a state of the fuel flowrate control system following a change of state that has moved the fuel flowrate control system away from the initial state, followed by
modifying the pressure of the fuel generated by the fuel pressurization system as a function of the state of the fuel flowrate control system that has been determined followed by a step of changing the state of the fuel flowrate control system to return the fuel flowrate control system to or toward the initial state.

2. The method as claimed in claim 1 of controlling a fuel supply device,
wherein the step of determining the state of the fuel flowrate control system comprises determining a direction of variation of the state of the fuel flowrate control system between a first direction of increase from the initial state toward the first extreme state and a second direction of reduction from the initial state toward the second extreme state,
wherein the step of modifying the pressure generated by the fuel pressurization system comprises modifying the pressure generated in the same direction of variation as the direction of variation that has been determined for the state of the fuel flowrate control system, and
wherein the step of changing the state of the fuel flowrate control system comprises modifying the fuel flowrate control system in a direction of variation opposite the direction of variation that has been determined.

3. The method as claimed in claim 2 of controlling a fuel supply device,
wherein the step of determining the state of the fuel flowrate control system comprises determining a value of the change of state between the initial state and the state that has been determined,
wherein the step of modifying the pressure generated by the fuel pressurization system comprises modifying the pressure generated by a value that is a conversion function of the value of the change of state that has been determined, and
wherein the step of changing the state of the fuel flowrate control system comprises modifying the fuel flowrate control system by a value substantially equal to the change of state value that has been determined.

4. The method as claimed in claim 3 of controlling a fuel supply device,
wherein the conversion function has an adjustable gain, and
wherein the control method includes a step of adjusting the gain of the conversion function in such a manner as to prevent the fuel flowrate control system becoming immobilized in one of the first or second extreme states or oscillating.

5. The method as claimed in claim 1 of controlling a fuel supply device,
wherein the range of states of the fuel flowrate control system includes a median state such that the range of states includes approximately as many states between the median state and the first extreme state as between the median state and the second extreme state, and
wherein the initial state corresponds to the median state.

6. The method as claimed in claim 1 of controlling a fuel supply device,
wherein the state of the fuel flowrate control system is determined by a sensor configured to generate a state signal as a function of the state that has been determined by the sensor, and
wherein the control method includes a step of processing the state signal.

7. The method as claimed in claim 6 of controlling a fuel supply device,
wherein the method includes a step of determining at least one intermediate state between the initial state and the state that has been determined by the sensor, and
wherein, for each intermediate state, the method includes a step of modifying the pressure generated by the fuel pressurization system as a function of the state that has been determined or of the preceding intermediate state of the fuel flowrate control system followed by a step of changing the state of the fuel flowrate control system to return the fuel flowrate control system to or toward the initial state.

8. A device for supplying with fuel an aircraft propulsion system enabling execution of the control method as claimed in claim 1, the supply device comprising:
at least one fuel pressurization system configured to compress the fuel to a given pressure, and
at least one fuel flowrate control system configured to occupy different states over a range of states bounded by first and second extreme states, to deliver to the propulsion system a given quantity of fuel at a given fuel pressure in each of the states and to occupy an initial state,
wherein the fuel flowrate control system includes a sensor configured to determine the state of the fuel flowrate control system and to generate a state signal as a function of the state of the fuel flowrate control system that has been determined, and
wherein the supply device is configured to control the fuel pressurization system and the fuel flowrate control system as a function of the state signal generated by the sensor.

9. The supply device as claimed in claim 8, wherein the sensor is configured to determine the state of the fuel flowrate control system, a direction of variation of the state and a change of state value between the initial state and the state that has been determined.

10. The supply device as claimed in claim 8,
wherein the range of states of the fuel flowrate control system includes a median state such that the range of states includes approximately as many states between the median state and the first extreme state as between the median state and the second extreme state, and
wherein the initial state corresponds to the median state.
